(19) United States
(12) Patent Application Publication
(10) Pub. No.: US 2009/0020202 A1
(43) Pub. Date: Jan. 22, 2009

(54) Method and Device for Manufacturing and Placing a Circumferential Reinforcement for a Tire and Tire Obtained According to Said Process

(76) Inventors: Nicolas Jaunet, Durtol (FR); Pierre Champommier, Vic-Le-Comte (FR); Christophe Ougier, Le Crest (FR); Thierry Dardelin, Cournon-D'Auvergne (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/793,221

(22) PCT Filed: Dec. 13, 2005
(86) PCT No.: PCT/EP2005/056720

§ 371 Date: Sep. 3, 2008

(30) Foreign Application Priority Data
Dec. 22, 2004 (FR) 0413788

(51) Int. Cl. B60C 5/00; B29D 30/08

(52) U.S. Cl. 152/450; 156/117; 156/397

(57) ABSTRACT

A method of manufacturing a circumferential reinforcement for a tire, said reinforcement comprising at least one thread (9) and an elastomeric material (12), in which said thread and a strip (38) of said elastomeric material in the unvulcanized state are wound simultaneously onto a form (21).

The present invention relates to the manufacture of tires. More specifically, it relates to the preparation and placement, during tire construction, of reinforcements intended to constitute a circumferential reinforcement of the tire. The present invention in particular proposes means and a method for the manufacture of such a reinforcement and for positioning it within the perform of a tire while it is being manufactured.

In the field of tires, when mention is made of reinforcement this means, within the elastomeric material, reinforcing elements (also simply known as “reinforcements”). These reinforcing elements or reinforcements are generally long linear elements and give the end product a rigidity and strength which are incomparable with the rigidity and strength of the matrix of elastomeric material.

Such reinforcements are often individually in the form of a very long thread. Thus, in the remainder of this application, the term “thread” must be understood in its most generalized sense, encompassing a monofilament, a multifilament, an assembly such as a cable or a folded yarn for example, or a small number of cables or folded yarns grouped together, regardless of the nature of the material, for example whether it be textile or metal.

Various families of methods and devices for manufacturing circumferential reinforcements and placing them in tires are already known.

A first type of method consists in first of all preparing plies of parallel threads, in coating these parallel threads with rubber, for example by calendering in order to form a very long semi-finished complex of the appropriate width. Next, this complex is wound onto the tire perform while the tire is being assembled. Laying entails as many turns as there are reinforcing layers (for example two turns for two layers).

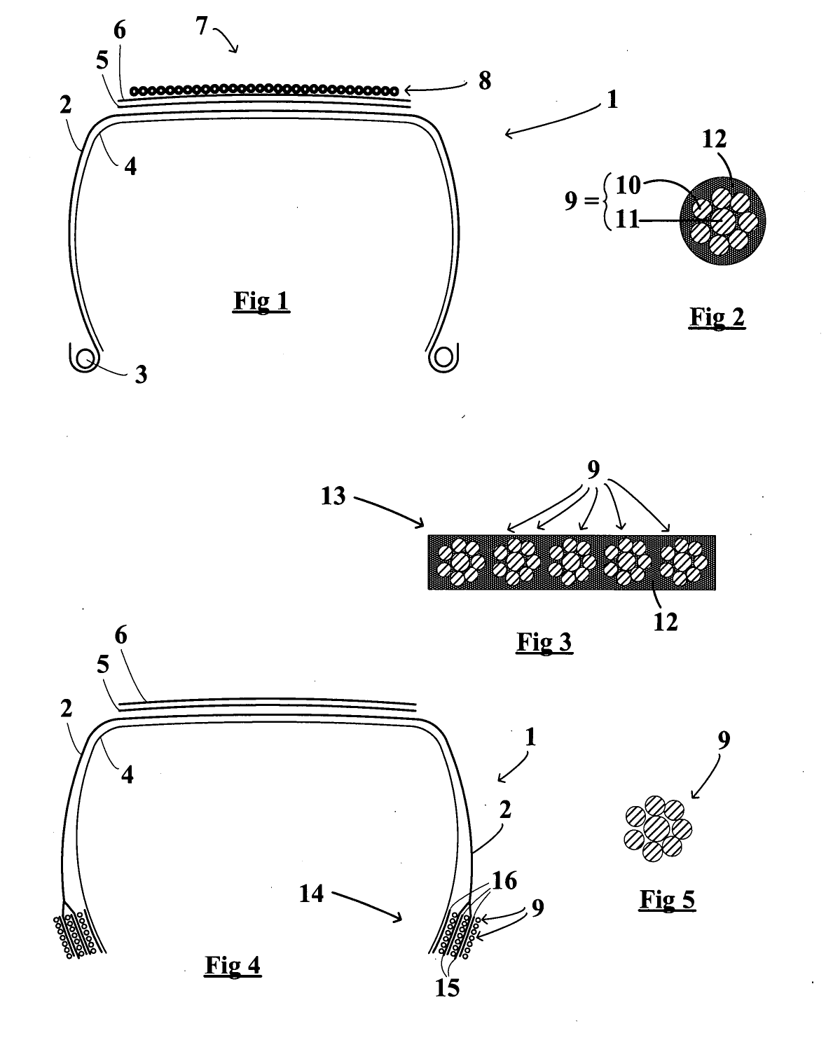

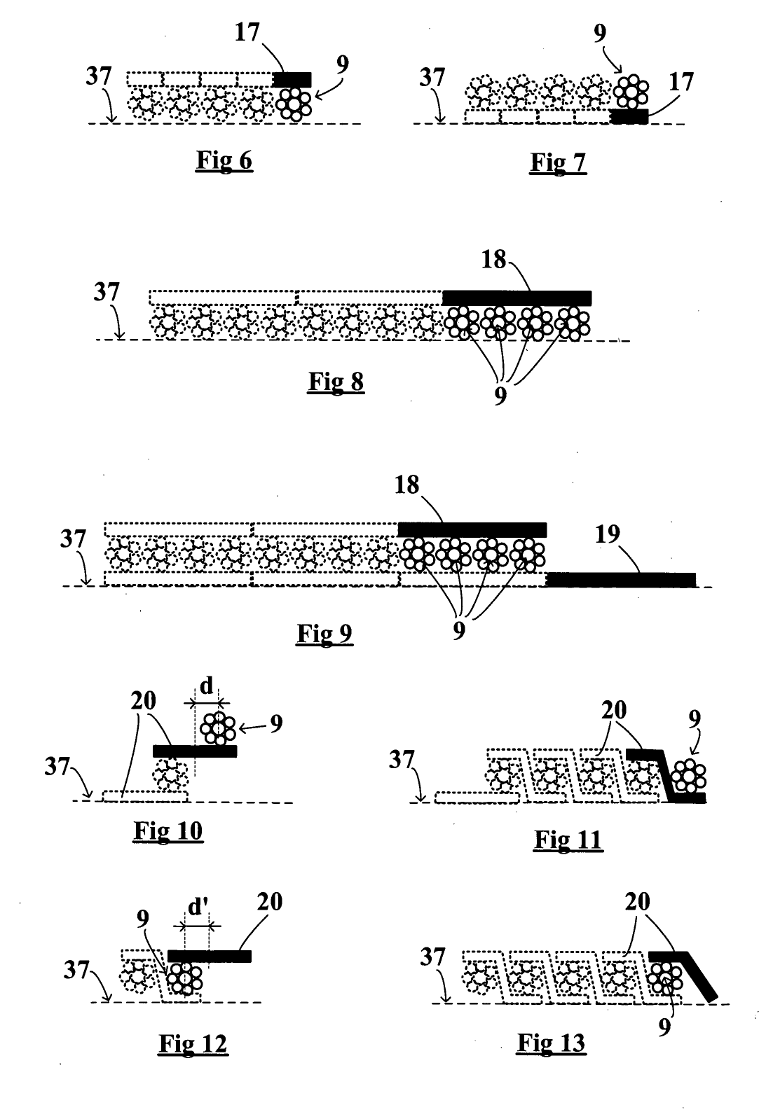

A second type of method consists first of all in coating a thread with a sheath of rubber, for example by extrusion. FIG. 2 depicts in cross section one example of such a “skimmed” or “coated” thread. Next, this coated thread is wound onto the tire perform while the tire is being assembled, for example to form a circumferential crown reinforcement as depicted in FIG. 1. Laying therefore entails as many turns as there are threads present in the reinforcement (for example 30 turns for the example of FIG. 1).

A third type of method that may be qualified as intermediate between the first two mentioned consists first of all in coating a limited number of threads (for example five) with rubber to form a reinforced narrow strip, for example as depicted in section in FIG. 3. Next, this narrow strip is wound onto the tire perform while the tire is being assembled. Laying therefore entails as many turns as there are reinforcement threads in total, divided by the number of threads in the narrow strip. For example, in order to obtain a result comparable with that of FIG. 1 from a five-thread narrow strip, six turns are needed. An example of a method of this type is described in patent application EP 0549311.

One difficulty that is encountered when laying coated reinforcements (for example in the form of plies, single threads or narrow strips as described above) has to do with preparing and storing these semi-finished products before they are laid in the tire. This series of steps entails the use of anti-stick means which are restrictive and relatively expensive.

It has also been envisioned for the thread to be “coated” immediately prior to winding it, for example by co-extrusion, so as to avoid the disadvantages associated with the use of semi-finished products. However, the phases of starting and stopping the winding are very difficult to achieve because of the “in-situ” co-extrusion, that is to say the co-extrusion in the immediate vicinity of the winding. In addition, the amount of rubber wound is directly linked to the length of thread wound, that is to say that the density of the reinforcement is constant and set for the duration of winding, even though it is often desirable for this density to be variable.

A fourth type of method consists in winding a “bare”, that is to say uncoated, thread onto the tire preform while the tire is being assembled. This laying of bare thread is performed between layers of rubber. These layers of rubber come either from other constituent parts of the tire or are provided specially for the purpose. This type of method is depicted schematically in FIG. 4 in respect of the construction of the beads of a tire. One difficulty that may be accounted when laying bare thread lies in guaranteeing sufficient adhesion between the thread and the tire preform in order to ensure that the threads will remain correctly in place through to the step of molding the tire. Another difficulty stems from the fact that alternatively laying threads on the one hand and strips of rubber on the other, entails numerous tool changes. These tool changes of course have a negative effect on the productivity of the production facilities and therefore on the industrial production cost.

One objective of the invention is a method which is able to alleviate at least some of the disadvantages identified hereinabove.

To do that, the invention proposes a method of manufacturing a circumferential reinforcement for a tire, said reinforcement comprising at least one thread and an elastomeric material, in which said thread and a strip of said elastomeric material in the unvulcanized state are wound simultaneously onto a form.

Preferably, a winding of the thread and a winding of the strip of elastomeric material are carried out onto a single laying surface of the form in a continuous sequence, the start and end of each of said windings being independent.

The invention also relates to a device for manufacturing a circumferential reinforcement for a tire, said device comprising conveying means for conveying a strip of unvulcanized elastomeric material, conveying means for conveying thread and a rotary form, said device being arranged in such a way as to allow the strip and the thread to be wound simultaneously and in a superposed manner onto the form.

The invention also relates to a tire obtained by the method described hereinabove. Preferably, the tire comprises a circumferential reinforcement, said circumferential reinforcement comprising a winding of several adjacent turns of a continuous thread, in which tire a winding of elastomeric material is interposed between the adjacent turns of the thread.

The remainder of the description will allow a clear understanding of all the aspects and advantages of the invention, with reference to the following figures:

FIG. 1 is a view in radial section of the architecture of a tire schematically illustrating a method according to the prior art;

FIG. 2 is a view of the cross section of a coated thread as used in the prior art;

FIG. 3 is a view of the cross section of a reinforced narrow strip as proposed in the prior art;

FIG. 4 is a view in radical section of the architecture of a tire schematically illustrating another method according to the prior art;

FIG. 5 is a view of the cross section of a bare thread as used in the prior art;

FIGS. 6 to 13 show, in cross section, various embodiments of a circumferential reinforcement according to the invention;

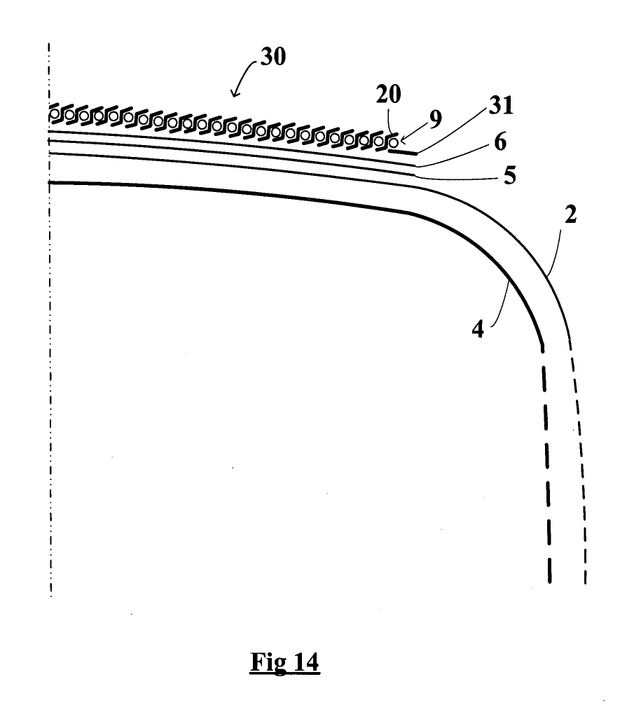

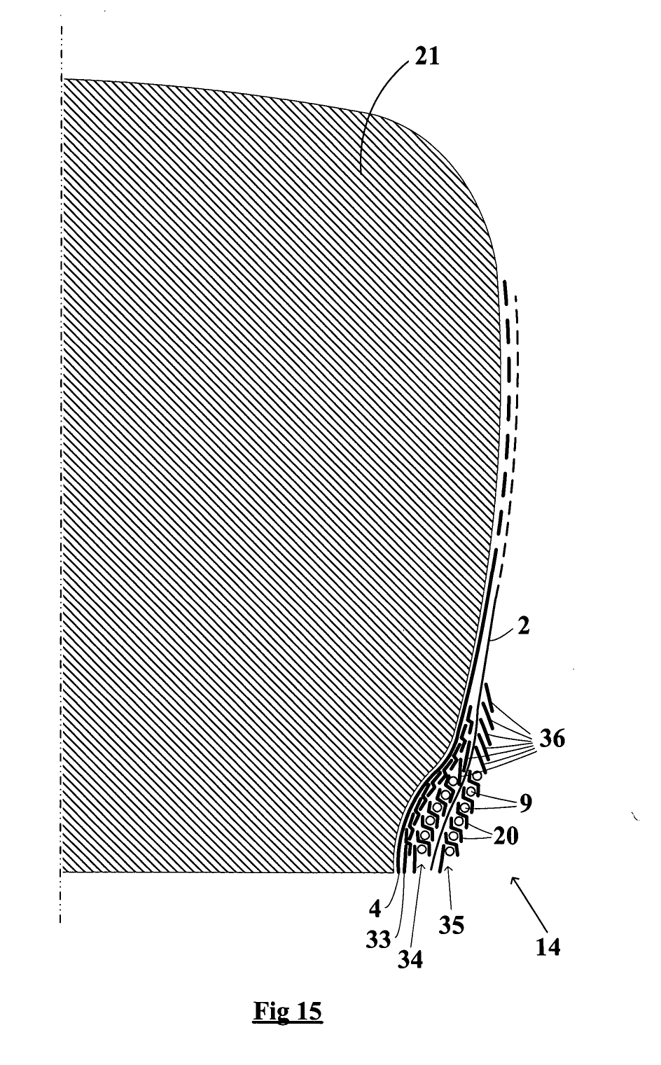

FIG. 14 is a view in radial cross section of the architecture of the crown of a tire schematically illustrating one embodiment of the invention;

FIG. 15 is a view in radial cross section of the architecture of the bead of a tire schematically illustrating one embodiment of the invention;

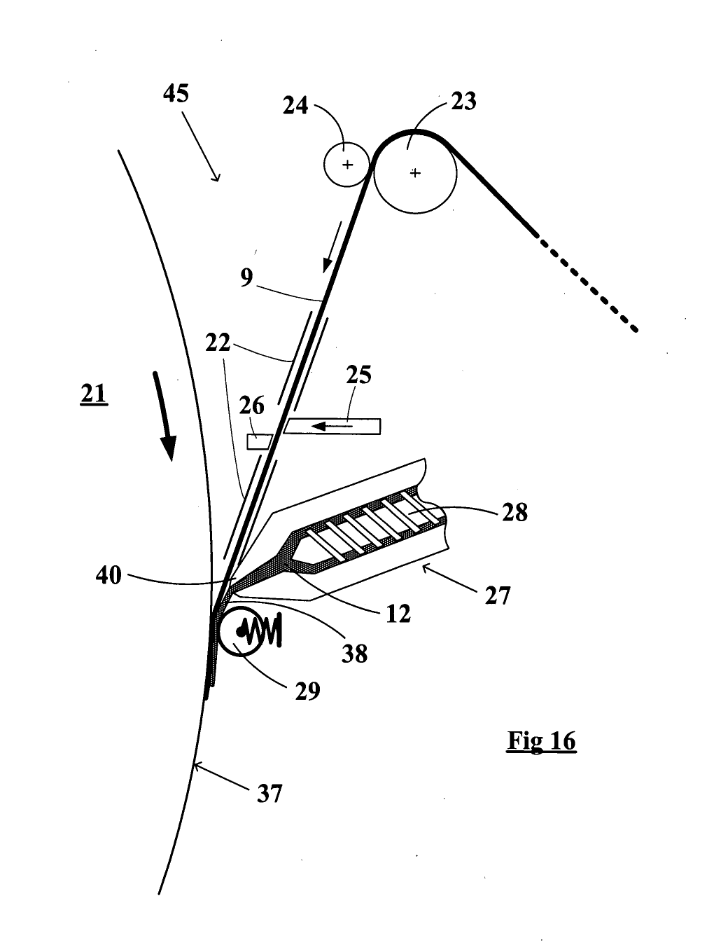

FIG. 16 is a schematic view of one embodiment of the manufacturing device according to the invention, applied to the laying of a circumferential crown reinforcement;

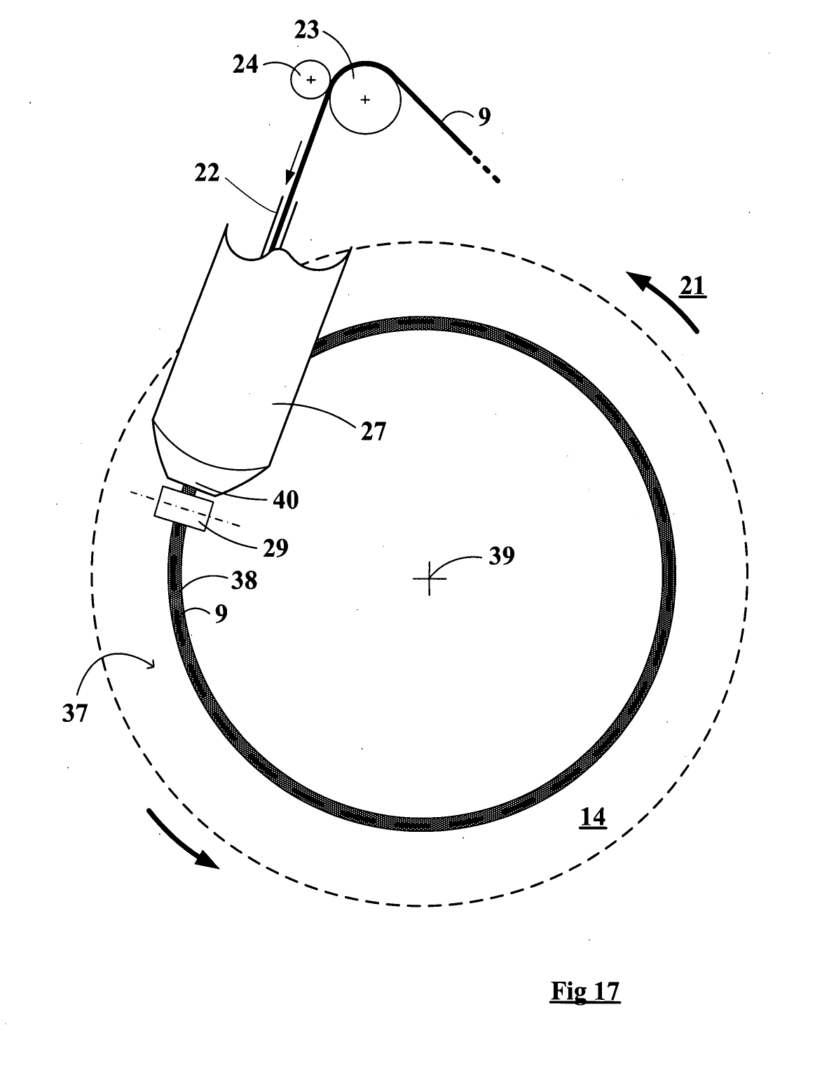

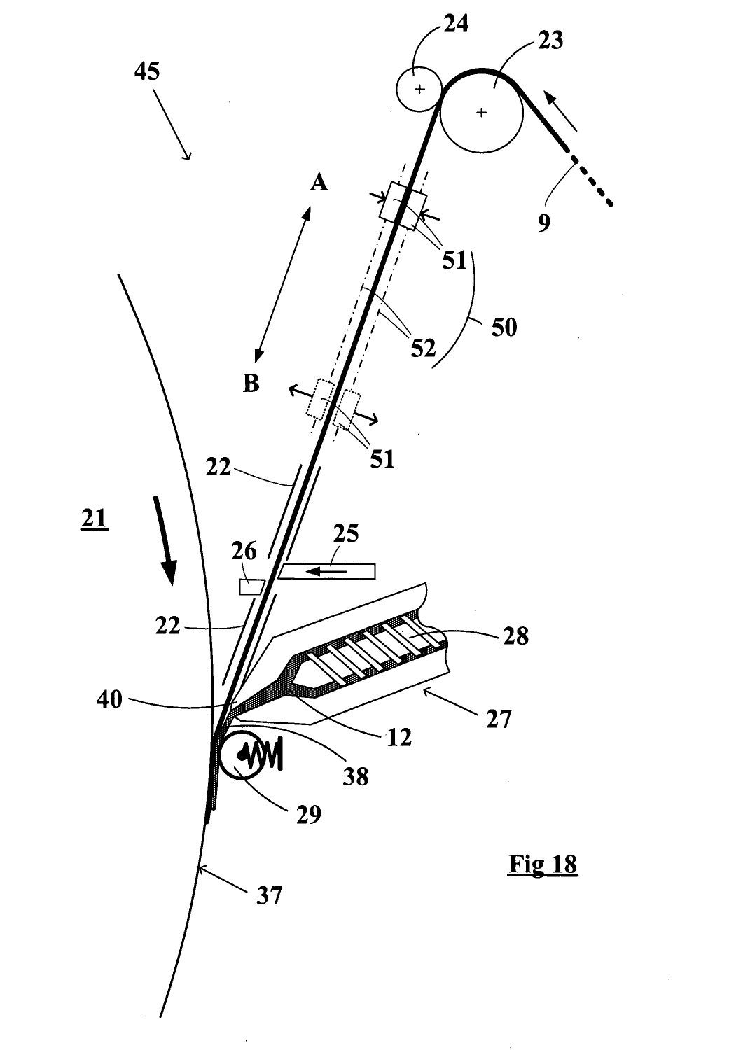

FIG. 17 is a schematic view of one embodiment of the manufacturing device according to the invention applied to the laying of a circumferential bead reinforcement;

FIG. 18 is a schematic view of a preferred embodiment of the manufacturing device according to the invention.

FIGS. 1 to 5 illustrate the prior art and allow the invention to be put into context.

FIG. 1 shows the conventional architecture of a tubeless radial tire. It generally comprises the following combination of elements:
a radial carcass 2 running from one bead to the other,
a bead wire 3 in each bead, for anchoring the tire onto the wheel,
an inner sealing layer 4,
two crossed reinforcing plies 5 and 6 in the crown 7.

In a way known per se, a circumferential reinforcement 8 may be added in order to further stiffen the crown region 7. According to a known method, this circumferential reinforcement may be formed by winding a suitable number of turns of a coated thread. An example of coated thread is depicted in section in FIG. 2. In this FIG. 2, the reinforcement is a cable 9 formed of six individual threads 10 arranged around a core thread 11. The cable 9 is surrounded by a sheath of elastomeric material 12 (the term “rubber” is often used to mean “elastomeric material”).

The coated threads may be fairly closely or loosely packed together within the circumferential reinforcement, their separation being determined by the laying pitch. The laying pitch can vary along the profile of the tire so as to adapt the reinforcement density to suit the requirements in each region of the crown 7. In FIG. 1, the laying pitch has been depicted as constant.

FIG. 3 depicts a cross section of a reinforced narrow strip 13. In this example it comprises five threads 9 similar to the cable in FIG. 2. This coated narrow strip may, for example, be obtained by calendering. One known method is then to wind such a very long narrow strip onto a tire perform in the manner of a coated thread but with the advantage of laying the equivalent of five turns of coated thread for each turn of narrow strip.

FIG. 4 depicts one example of an architecture in which it is the bead 14 which comprises several layers of circumferential reinforcement. Such a circumferential reinforcement may replace the bead wires of FIG. 1. Other examples of architectures of beads of this type are also described in patent application EP 0 582 196. This type of bead is advantageously constructed on a (flexible or rigid) core the shape of which corresponds substantially to that of the interior cavity of the finished tire. Each layer of circumferential reinforcement is formed by winding an appropriate number of turns of bare thread 9. Each layer of bare thread is laid in alternation with layers of rubber 16. In the example depicted, the circumferential reinforcing layers are three in number and the carcass reinforcements 2 are anchored alternately on each side of the central layer of the bead.

FIG. 5 shows a cross section through an example of bare thread 9 in the form of a cable comparable with those of FIGS. 2 and 3.

The method of laying a bare thread as illustrated in FIG. 4 can be applied to the construction of a circumferential crown reinforcement. Conversely, the method of laying a coated thread as illustrated in FIG. 1 can be applied to the construction of a circumferential bead reinforcement.

FIGS. 6 to 14 now more specifically illustrate the benefit of the present invention. One principle of the invention is that it allows a strip of rubber and a thread to be wound simultaneously around a form. This form may be a tire perform at various stages in its manufacture, a making-up drum, a flexible or rigid core, a mold or a temporarily annular support that allows a circumferential reinforcement to be formed in its finished or almost-finished state before it is combined with a tire perform.

FIG. 6 depicts part of a circumferential reinforcement according to the invention. In this embodiment, a bare thread 9 and a strip of rubber 17 are wound simultaneously. The strip of rubber is positioned on top of the thread 9 with respect to the laying surface 37. The juxtaposition of the successive turns of the winding gradually builds up a circumferential reinforcing layer. Laying is from left to right, the threads depicted in dotted line having already been laid when the thread depicted in solid line comes to be laid (this symbolic representation is also used in FIGS. 7 to 14).

In FIG. 7, the laying is reversed by comparison with FIG. 6, that is to say that the strip of rubber 17 is laid between the laying surface 37 and the bare thread 9. One advantage with this variant may be better immobilization of the thread and especially of the rubber with respect to the laying surface.

FIG. 8 depicts a variant of FIG. 6. In this variant, several bare threads 9 are wound simultaneously and covered with a broad strip of rubber 18. One potential advantage with this variant is better productivity because laying a similar circumferential reinforcement here requires fewer turns (one quarter of the number in this example). The separation between two adjacent threads corresponds to a fraction of the laying pitch.

Alternatively, the strip of rubber 18 may be positioned between the laying surface 37 and the bare threads 9, in a similar way to that which is illustrated in FIG. 7.

FIG. 9 depicts an embodiment similar to that of FIG. 8 but in which a second strip of rubber 19, offset by one laying pitch with respect to the threads 9 and with respect to the first strip of rubber 18 is wound on at the same time. Thus, a sandwich consisting of a certain number of threads (in this instance four threads per turn) positioned between two layers of elastomeric material is gradually formed. Laying is from left to right in the figure, as it was in the previous figures.

FIGS. 10 to 13 show another embodiment of the invention in which a thread 9 and a strip of rubber 20 are wound at the same time, the strip of rubber having a width greater than the diameter of the thread, and the thread possibly being offset with respect to the strip of rubber.

In FIGS. 10 and 11, the thread is laid over the top of the strip of rubber, offset by a distance “d” in the laying direction. The dimensions of the thread and of the strip and the distance d are such that the strip of rubber from one given turn at least partially covers the thread laid during the previous turn (see FIG. 10). The strip of rubber 20 therefore finds itself partially under a thread and partially over an adjacent thread. The central part of the strip of rubber for its part is trapped between two adjacent threads.

In FIGS. 12 and 13, the thread is laid under the strip of rubber 20, offset in the opposite direction to the laying direction by a distance “d′” with respect to the strip of rubber. The dimensions of the thread and of the strip and the distance d′ are such that the strip of rubber of one given turn finds itself at least partially covered by the thread laid during the next turn (see FIG. 13). As in FIG. 11, the strip of rubber 20 lies partially under a thread and partially on top of an adjacent thread and its central part separates these two threads. One advantage that this embodiment has over that of FIGS. 10 and 11 is that the strip of rubber is better able to hold the thread in place on the laying surface 37, that is to say to prevent it from moving on the form after laying, a little in the manner of a sticky tape.

It will be understood that the distribution (within the finished tire) of the elastomeric material between the top surface and bottom surface of the threads 9 is dependent on the dimensions of the thread and of the strip of rubber and on the magnitude of the offset d or d′ with respect to the laying pitch. In particular, for a given offset, depending on the width of the strip with respect to the laying pitch, the winding of each turn of thread will to a greater or lesser extent overlap the winding of the strip of rubber of the previous turn and will therefore have the effect of leading a greater or lesser proportion of the strip of rubber under the threads. For example, it has been found that in the case depicted in FIGS. 12 and 13, for a strip 8 mm wide, a thread 1.5 mm in diameter and a zero offset (d′=0), the result was a reinforcement in which the amount of rubber situated on top of the threads was approximately 1.5 times the amount of rubber located under the threads.

The distribution of elastomeric material between the top surface and the underside of the threads is also dependent on the profile of the strip of rubber. This profile here is depicted as being symmetric but the strip could equally have a different thickness on one side compared to the other.

One advantage of the embodiment of FIGS. 10 to 13 is that the threads are definitely separated from one another by a substantially constant thickness of rubber.

The strip of rubber 20 may be conveyed in the form of a flat profile as depicted here and adopt its wavy shape only as a result of the deformations imposed by the threads 9. However, the strip of rubber could equally be conveyed into the laying zone in the form of a corrugated profile more similar to the final profile.

FIG. 14 schematically shows an example of a crown architecture obtained according to the invention. This figure confines itself to depicting the main elements of half of the crown of a tire. Here again, we see the carcass 2, the inner sealing layer 4 and the crossed reinforcing plies 5 and 6 of FIGS. 1 and 4. The circumferential reinforcement 30 consists of an appropriate number of turns of a thread 9 and of a strip of rubber 20. This circumferential reinforcement may in this instance be obtained by simultaneously winding a thread 9 onto a strip of rubber (31 then 20) using the method described in FIGS. 10 and 11 (although here laying is from right to left). This circumferential reinforcement may equally be obtained by simultaneously winding a thread 9 under a strip of rubber 20 using the method described in FIGS. 12 and 13 (laying from right to left). In the latter instance, in order to obtain the result depicted, the first strip of rubber 31 is wound by itself for a complete revolution of the tire perform before simultaneous winding with the thread 9 is began. During the second turn of the winding, the strip of rubber therefore bears the reference 20.

The laying described here of the circumferential crown reinforcement may take place as part of a construction method on a flexible or rigid core or as part of a method comprising a step of making-up on a cylindrical drum and a step of placing the crown elements once the initial perform has been inflated.

FIG. 15 schematically shows an example of the architecture of a bead as obtained according to the invention. This figure confines itself to depicting the main elements of just one bead 14 of a tire.

Once again we have the carcass 2 and the inner sealing layer 4 from FIGS. 1 and 4. In this example, the carcass 2 is not doubled back in the bead 14 (as it was in FIG. 4). The carcass is simply anchored between two circumferential reinforcing layers 34 and 35.

In this instance the bead is constructed on a form 21 the function of which is to at least approximately reproduce the profile of the interior cavity of the tire.

The circumferential reinforcement consists of threads 9 and various strips of rubber, some strips being laid at the same time as and others independently of the thread. The construction of such a bead may, for example, comprise the following successive steps:
laying the inner sealing layer 4 on the form 21;
laying a first layer of bead rubber 33 on the inner sealing layer 4. This bead layer 33 may consist of the winding of a strip of rubber with a suitable overlapping of each turn over the previous turn. This example depicts winding from the bottom up in the figure, that is to say radially toward the outside of the tire;
laying an inner circumferential reinforcement 34 on the layer of bead rubber 33. This circumferential reinforcement may consist of several turns of a simultaneous winding of a thread and of a strip of rubber, the thread being laid on top of the strip of rubber, in the manner described in FIGS. 10 and 11. This example depicts winding from the bottom up in the figure, that is to say radially toward the outside of the tire. Just two turns of winding of rubber 36 here cover the last thread of the inner circumferential reinforcement 34. Another way of obtaining the depicted result is to produce one turn of winding of rubber alone followed by six turns of simultaneous winding of thread and rubber strip, the strip of rubber being laid on top of the thread in the manner described in FIGS. 12 and 13;
laying the carcass reinforcement 2 on top of the inner circumferential reinforcement 34 in such a way that there is an appropriate radial overlap with the inner circumferential reinforcement 34;
laying an outer circumferential reinforcement 35 on the carcass 2. This outer circumferential reinforcement may be constructed in the same way as the inner circumferential reinforcement 34. The figure depicts winding from the bottom up, that is to say radially toward the outside of the tire. Several turns of rubber alone 36 here cover the last thread of the circumferential reinforcement and provide a gradual transition between the bead and the sidewall from a thickness standpoint.

One benefit of this type of construction is that it allows the profiles and densities of the circumferential reinforcements to be varied without any change either in tooling or in components (thread, rubber) supplied. All that is required is for the laying program to be adapted to suit in order to obtain the desired result.

The bead architecture may adopt many forms other than the one depicted here. Patent application EP 0 582 196 describes other examples. These various architectures can be achieved using the present invention. The view of FIG. 15 clearly demonstrates the advantage that the fact that the strip of rubber comes into contact with the laying surface while at the same time covering all or part of the thread may afford. The adhesion of the unvulcanized rubber in fact allows the thread to be held in the laying position even when the rigidity and the self-weight of the thread have a tendency to move it away from this position. This is of particular benefit in circumferential bead reinforcements based on metal cables. A similar effect may be obtained by limiting the supply of rubber by intermittent supply. The strip of rubber is then replaced by a series of bits of rubber strip separated from one another. One advantage of this variant is of course that it makes it possible to limit the amount of rubber used compared with a continuous strip. This blocking effect is also of benefit in the case of circumferential crown reinforcements (FIG. 14), especially when the crown profile is very highly curved as is the case in particular for motorcycle tires.

FIG. 16 depicts one embodiment of the device for manufacturing a circumferential reinforcement according to the invention.

The device comprises conveying means for conveying the thread 9. These conveying means for conveying the thread may comprise pulleys or rollers 23 and 24 and tubular guides 22 intended to guide the thread toward the laying surface 37 with the desired precision. During winding, thread progression is ensured by rotation of the form and may also be controlled by rotation of the pulleys or rollers 23 and 24. Preferably, high-speed cutting means are provided so that the thread can be cut without that impeding either the laying of the downstream part of the cut thread or the guidance of the upstream part of the thread. The high-speed cutting means may comprise a moving blade 25 and a fixed anvil 26 and allow the laying of the thread to be interrupted “on the fly”, that is to say without substantially changing the rate of rotation of the form or, at the very least, without there being any need to stop its rotation.

The device also comprises conveying means for conveying a strip of unvulcanized elastomeric material. Preferably, the conveying means comprise an extruder 27 able to produce at least one strip of rubber 38 from an unvulcanized elastomeric material 12. Preferably, the extruder is a volumetric extruder, that is to say an extruder the flow rate of which can be controlled relatively precisely by controlling the rate at which its screw 28 turns. Document EP 690229 describes examples of volumetric extruders.

The form 21 is rotated (in this instance toward the bottom of the figure) in such a way as to allow the thread 9 and the strip of rubber 38 to be wound on as they are conveyed. The form 21 may be a tire perform on which a circumferential crown reinforcement like the one described in FIG. 14 is laid.

Preferably, as depicted here, the nozzle 40 of the extruder 27 opens directly onto the form 21, that is to say that the strip of rubber is extruded immediately prior to winding. One advantage is that the rubber undergoes practically no cooling before it comes into contact with the thread and the laying surface.

Preferably, pressing means, for example involving rollers 29, press the thread and/or the strip of rubber against the form 21.

According to the arrangement of the device as depicted here, the thread is laid down between the strip of rubber 38 and the form 21, but a different arrangement would allow the thread to be laid on top of the strip of rubber laid down at the same time.

The nozzle 40 may have a single outlet or several parallel outlets; it may equally comprise several outlets in different planes, for example for supplying rubber simultaneously onto or under the thread and at the same time laying a second strip of rubber which is offset as depicted in FIG. 9.

This figure clearly demonstrates that the device allows the thread and a strip of rubber to be laid simultaneously, but also completely independently. To do that, all that is required is independent control of the various conveying means and of the high-speed cutting means. For example, it is possible according to the invention to alternate simultaneous windings of thread and rubber strip with windings of just rubber or windings of just thread. It is possible in this way to vary the amount of rubber contained in the circumferential reinforcement without changing either the nozzle or the nominal delivery rate of the extruder.

Controlling the rates of supply and the rate of rotation of the form makes it possible to vary the tension of the thread and/or of the strip of rubber. It is in particular possible to elect to lay the rubber under tension in order to reduce its thickness or under compression in order locally or systematically to increase this same thickness.

Let us use “laying means” as the term used to define the assembly 45 comprising the conveying means for supplying the thread, the conveying means for supplying the strip of rubber and the pressing means.

Scanning means (not depicted) allow the form 21 or the laying means 45 to be moved axially and/or radially relative to one another. This scanning allows the circumferential reinforcement to be laid in the form of a winding in which the successive turns are adjacent. Thus, the assembly of laying means may constitute a unit of which the movements with respect to the axis of rotation of the form can be controlled by a single actuator. Scanning may result from a movement imparted to the form and/or from a movement imparted to the laying means. The laying pitch is determined by the relationship between the rate of rotation of the form and the scanning rate.

However, adjusting means (not depicted here) for adjusting the relative position of the thread and of the strip (or strips) of rubber may allow the relative position of the thread and of the strip of rubber to be altered, that is to say may allow the magnitude of the offset (d, d′ in FIGS. 10 to 13) to be altered without a change of nozzle 40. This adjustment may even be performed dynamically and controlled in such a way that it changes over the course of a laying operation. In any event, this adjustment is on a small scale by comparison with the magnitude of the scanning movement described above.

If the device is used for laying several threads in parallel (see FIGS. 8 or 9), the conveying means for supplying the thread and the high-speed cutting means must, of course, be adapted to suit.

FIG. 17 depicts a device similar to that of FIG. 16 but implemented here for manufacturing a circumferential bead reinforcement 14, for example like the one described in FIG. 15.

The form 21 revolves about its axis 39 and gradually receives a winding of thread 9 and rubber strip 38. The first turn is depicted here. In order to lay several adjacent thread turns, the laying means are able to move radially relative to the form, or vice versa. The circle drawn in dotted line represents the radially outer limit of the envisioned circumferential bead reinforcement 14. Winding may be done radially outward as depicted here and in FIG. 15, but equally may be done from the outside inward. The scanning means allow the laying means to be moved radially relative to the form.

FIG. 18 illustrates a preferred embodiment of the invention in which the conveying means for supplying the thread further comprise thread starting means. The starting means 50 comprise a gripper 51 and a guide 52 allowing the gripper 51 to move along the path of the thread. The starting means may for example operate as follows: from the moment that the thread is cut by the cutting means (25, 26) it is no longer carried by the rotation of the form. The gripper which, at that moment, occupies the position A, closes and thus blocks any supply of thread. The winding of rubber may, however, continue independently. When the winding of thread is to be resumed, the closed gripper 51 moves in the direction of thread supply toward its position B on the guide 52. Having reached the position B, the gripper can then be opened to release the thread, the free end of which is once again in contact with the rotary form in the laying region. The magnitude and speed of this movement of the gripper may allow the winding of thread to be begun “on the fly”, that is to say may allow a further winding of thread to be undertaken without a substantial change in the rate of rotation of the form or at the very least without there being any need to stop its rotation.

The gripper has been depicted closed in position A (solid line) and open in position B (dotted line). The starting means allow thread winding to be resumed at any moment after the thread has been cut but they may of course also be used when beginning the first turn of a winding.

It will be understood that the device of the invention thus allows a thread and a strip of rubber to be laid simultaneously, but also allows the rubber to be laid without the thread or the thread to be laid without the rubber, the switch from one type of laying to another being possible without necessarily interrupting or slowing the winding that is ongoing.

As was seen during the description of FIG. 15, a laying sequence may comprise several interruptions in the winding of the thread. If the device of FIG. 18 is used to obtain the circumferential bead reinforcement of FIG. 15, then the sequence of operations may be as follows:
laying ten turns of rubber without any thread on top of the inner sealing layer 4 in order to obtain the first layer of bead rubber 33;
laying one turn of rubber alone on top of the layer of bead rubber 33;
starting the thread and laying six turns of simultaneous winding of thread and rubber on top of the layer of bead rubber 33 in order to produce the inner circumferential reinforcement 34, the thread being laid under the strip of rubber;
cutting the thread and continuing to wind one turn of rubber without thread;
interrupting the supply of rubber strip;
laying the carcass reinforcement 2 on top of the inner circumferential reinforcement 34 (using other means not detailed here);
laying one turn of rubber on top of the carcass 2;
starting the thread and laying six turns of simultaneous winding of thread and rubber on top of the carcass in order to produce the outer circumferential reinforcement 35, the thread being laid under the strip of rubber;
cutting the thread and continuing to wind four turns of rubber without thread;
interrupting the extrusion of rubber strip.

This example of a method in fact comprises a first continuous laying sequence (rubber alone then rubber+thread then rubber alone) prior to laying the carcass reinforcement and a second continuous laying sequence (rubber alone then rubber+thread then rubber alone). During each of these two sequences, the laying device is able to lay the various products in succession and continuously, that is to say without halting the rotation of the form and therefore without stopping the winding of the product or products.

Preferably, according to the invention, extrusion of the strip of rubber occurs (as depicted here) in the immediate vicinity of the form. One advantage of this setup is that it allows precise control over the amount of rubber laid. Control of the manufacturing process (rotation of the form, radial or axial scan, cutting and starting of the thread) can also be based on the rotation of the screw of the volumetric extruder.

In this application, when the strip of rubber laid on the form is said to be “unvulcanized” that means that it is not “cured” with reference to the crosslinking which generally takes place during final molding of the tires. In practice, the crosslinking may be begun before molding, for example as a result of the increase in temperature caused in the strip of rubber by extrusion. Thus, it must be understood that the elastomeric material is said to be “unvulcanized” as long as it is not yet fully crosslinked.

When a thread is said to be “bare”, that means that it has not been “coated” with rubber. The thread is coated if it is covered with a sheath of rubber able to provide the amount of rubber needed for the envisioned reinforcement, that is to say without any additional rubber being required. The bare thread may, however, be covered with any treatment intended for example to protect it from oxidation or encourage subsequent bonding with the matrix of elastomeric material. As a result, the thread may still be termed a “bare thread” even if the treatment contains an elastomeric material.

The strip of rubber that is wound onto the form may have a rectangular profile like the one depicted in the figures but may equally have any profile suited to the requirement, both in terms of thickness in order to tailor the amount of rubber precisely and in terms of shape, for example in order to best tailor itself to the presence of the thread or threads laid before, at the same time or after the turn of winding considered. In the case of a strip of rubber that has been extruded, its profile is determined in particular by the extrusion nozzle.

1. A method of manufacturing a circumferential reinforcement for a tire, said reinforcement comprising at least one thread (9) and an elastomeric material (12), in which said thread and a strip (20) of said elastomeric material in the unvulcanized state are wound simultaneously onto a form (21).

2. The method as claimed in claim 1, in which a winding of the thread and a winding of the strip of elastomeric material are carried out onto a single laying surface (37) of the form (21) in a continuous sequence, the start and end of each of said windings being independent.

3. The method as claimed in claim 1, in which the strip of elastomeric material is extruded immediately prior to being wound onto the form.

4. The method as claimed in claim 3, in which the strip of elastomeric material is extruded in the immediate vicinity of the surface of the form.

5. The method as claimed in claim 1, in which the strip of elastomeric material and the thread which are wound simultaneously are superposed on the form.

6. The method as claimed in claim 5, in which the strip of elastomeric material is wound over the top of the thread wound simultaneously.

7. The method as claimed in claim 1, in which, during a given turn in the winding, the thread becomes superposed with the strip of elastomeric material laid during a different turn.

8. The method as claimed in claim 1, in which the strip of elastomeric material and the thread are pressed against the form as they are being laid.

9. The method as claimed in claim 1, in which, during a given turn in the winding of the strip of elastomeric material onto the thread, the thread is also wound onto the strip of elastomeric material laid in the previous turn of the winding.

10. The method as claimed in claim 1, in which the laying of the thread is interrupted, the laying of the strip of elastomeric material continuing without any substantial change in the rate of rotation of the form.

11. The method as claimed in claim 1, in which the laying of the thread begins during a winding of the strip of elastomeric material, the laying of the thread and of the strip continuing with no substantial change in the rate of rotation of the form.

12. A device for manufacturing a circumferential reinforcement for a tire, said device comprising conveying means (27) for conveying a strip of unvulcanized elastomeric material (20; 38), conveying means (22, 23, 24) for conveying thread (9) and a rotary form (21), said device being arranged in such a way as to allow the strip and the thread to be wound simultaneously and in a superposed manner onto the form.

13. The device as claimed in claim 12, further comprising pressing means, particularly involving rollers, allowing the thread and/or the elastomeric strip to be pressed against the form.

14. The device as claimed in claim 1, in which the conveying means for conveying a strip of unvulcanized elastomeric material comprise an extruder (27) situated in the immediate vicinity of the surface of the form.

15. The device as claimed in claim 14, in which the extruder is a volumetric extruder the extrusion nozzle of which opens directly onto the rotary form.

16. The device as claimed in claim 12, further comprising high speed cutting means (25, 26) for cutting the thread.

17. The device as claimed in claim 12, further comprising thread starting means able to engage the free end of the thread with the rotary form.

18. The device as claimed in claim 12, in which the conveying means for conveying the strip of elastomeric material and the conveying means for conveying the thread are secured together, their movements with respect to the axis of rotation of the form being controlled by a common actuator.

19. A tire obtained by the method as claimed in claim 1.

20. The tire as claimed in claim 19, comprising a circumferential reinforcement, said circumferential reinforcement comprising a winding of several adjacent turns of a continuous thread (9), in which tire a winding of elastomeric material (20) is interposed between the adjacent turns of the thread.
